(19) United States
(12) Patent Application Publication
(10) Pub. No.: US 2009/0021613 A1
(43) Pub. Date: Jan. 22, 2009

(54) Video camera apparatus

(75) Inventors: Shingo Ito, Yokohama (JP); Yuichi Katano, Yokohama (JP); Morio Aoki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/154,689

(22) Filed: May 22, 2008

(30) Foreign Application Priority Data
Jul. 17, 2007 (JP) 2007-185848

(51) Int. Cl. H04N 7/01

(52) U.S. Cl. 348/252; 348/E07.003

(57) ABSTRACT

Under circumstances where various recording formats are employed for HD (high-definition) images, the present invention provides a user-friendly video camera apparatus that can be used in a variety of user environments. An HD mode video signal picked up by an imaging unit is encoded to video data in the H.264 format and recorded onto an HDD. A decoder and an encoder transcode the video data reproduced from the HDD to video data in the MPEG2 format, whereas a resolution conversion module performs a resolution conversion process to obtain SD (standard-definition) mode video data. The converted data is dubbed to an optical disc (DVD) for recording purposes.

### CLAIM OF PRIORITY

The present application claims priority from Japanese application serial no. JP 2007-185848, filed on Jul. 17, 2007, the content of which is hereby incorporated by reference into this application.

### BACKGROUND OF THE INVENTION

The present invention relates to a video camera apparatus that records picked-up images onto a hard disk, optical disc, or other medium.

In recent years, the recording medium incorporated in household video cameras has mostly changed to a disc medium because users do not possibly overwrite video recordings and can easily search for desired video images. An optical disc such as a DVD or hard disk (HDD) is used as a disc medium. Some new products incorporate a semiconductor memory. Further, efforts are being made to increase the capacity of the recording medium and provide a high-quality image recording method so that the video cameras can record high-quality images for an extended period of time.

As large-capacity optical discs, a next-generation optical disc called Blu-ray Disc or BD, which is formulated by BDA (Blu-ray Disc Association), and an HD-DVD defined by the DVD Forum are developed. These discs are capable of recording not only conventional standard definition (SD) mode images but also high-definition (HD) mode images without sacrificing their image quality.

Conventional DVDs cannot directly record HD images. However, the AVCHD (Advanced Video Codec High Definition) standard, which incorporates a new coding method, is established to permit HD images to be recorded on conventional DVDs. The configuration of a codec IC conforming to the AVC/H.264 coding standard is disclosed, for instance, in Japanese Patent JP-A-2005-229331.

Meanwhile, a stationary apparatus such as an HDD/DVD recorder is capable of dubbing video recordings from an HDD to a DVD. A technology for skipping broadcast commercial messages during dubbing is disclosed, for instance, in Japanese Patent JP-A-2006-339730. The use of the dubbing function of the stationary apparatus makes it possible to record an HD image broadcast in the MPEG2-TS mode onto the HDD, convert the recorded image into the MPEG2-PS mode and SD image rate (resolution), and dub the resulting image to a DVD to record the image onto the DVD.

### SUMMARY OF THE INVENTION

Video cameras and other mobile apparatuses may record HD images not only in the MPEG2-TS mode but also in the H.264 or AVCHD format. The H.264 format exhibits a high compression ratio and is suitable for HD image storage. However, the use of the H.264 format limits the recording medium to BDs or HD-DVDs. The BDs and HD-DVDs are more expensive than conventional DVDs. It is therefore preferred that inexpensive DVDs be capable of recording HD images before the BDs and HD-DVDs become widespread. The use of the AVCHD method makes it possible to directly record HD images onto a DVD. However, it goes without saying that such image recordings can only be reproduced by a player that supports the AVCHD method.

Meanwhile, a hybrid apparatus having an HDD and optical disc can record HD images onto a HDD in the H.264 format and dub the recorded image to an optical disc for storage purposes. However, the optical discs for such dubbing are limited to BDs and HD-DVDs. In other words, HD images cannot be stored on conventional DVDs that do not support the H.264 recording format. Consequently, when, for instance, optical discs to which HD images are dubbed are distributed, the HD images can only be reproduced in an environment that supports the H.264 format. This situation is far from being user-friendly.

The present invention has been made in view of the above circumstances where various recording formats are employed for HD images. An object of the present invention is to provide a user-friendly video camera apparatus that can be used in a variety of user environments.

According to one aspect of the present invention, there is provided a video camera apparatus that records a video signal picked up by an imaging unit onto a hard disk medium and an optical disc medium, the video camera apparatus comprising: an encoding/decoding process module which performs an encoding/decoding process on the video signal by a predetermined coding method; a resolution conversion module which converts the resolution of the video signal; a recording/reproduction module which records the video signal onto the hard disk medium and optical disc medium and reproduces the recorded video signal; and a control module which controls the encoding/decoding process module, the resolution conversion module, and the recording/reproduction module. The control module encodes a high-definition mode image signal picked up by the imaging unit into video data in a first coding format, records the resulting video data onto the hard disk medium, transcodes the video data in the first coding format, which is reproduced from the hard disk medium, to video data in a second coding format while converting the resolution of the video data in the first coding format to obtain standard mode video data, and dubs the resulting video data to the optical disc medium.

The present invention provides enhanced user-friendliness by allowing the user to choose from a wide variety of media and formats for storing picked-up images.

### BRIEF DESCRIPTION OF THE DRAWINGS

The above and other features, objects, and advantages of the present invention will become more apparent from the following description when taken in conjunction with the accompanying drawings, wherein:

FIG. 1 is a block diagram illustrating a video camera apparatus according to an embodiment of the present invention;

FIG. 2 is a block diagram illustrating the internal configuration of a system control module;

FIG. 3 is a flowchart illustrating the steps for performing a dubbing process;

FIG. 4 is a flowchart illustrating the steps for performing a transcoding process;

FIG. 5 is a flowchart illustrating the steps for automatically judging a dubbing destination disc;

FIG. 6 shows an example of a “Dubbing Menu” screen;

FIG. 7 shows an example of a “Disc Setup” screen;

FIG. 8 shows an example of an “Image Quality Setup” screen;

FIG. 9 shows an example of an “Automatic Division Setup” screen; and

FIG. 10 shows an example of a “Confirmation” screen.

### DETAILED DESCRIPTION OF THE EMBODIMENTS

An embodiment of the present invention will now be described with reference to the accompanying drawings.

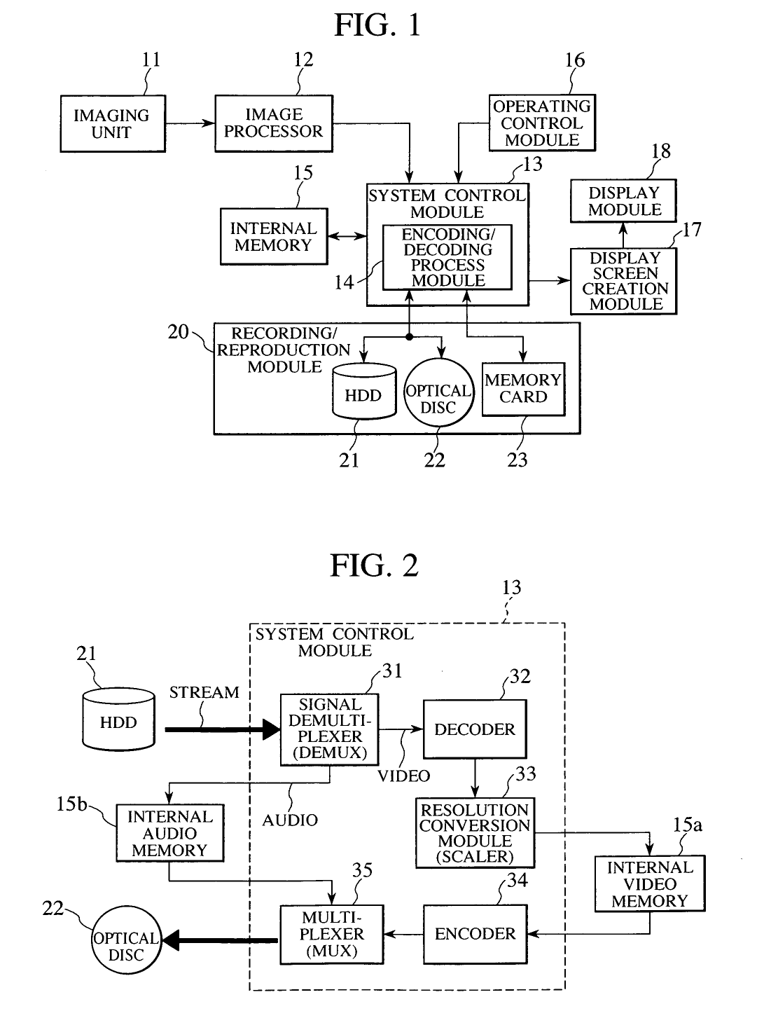

FIG. 1 is a block diagram illustrating a video camera apparatus according to an embodiment of the present invention.

An imaging unit 11 includes an optical lens, which images an object, and a CCD sensor or CMOS sensor, which converts the resulting image into an electrical signal. An image processor 12 receives the electrical signal from the imaging unit 11, converts the electrical signal to a digital signal, and converts image information to an image signal. Further, the sound captured by a microphone (not shown) is converted to a digital audio signal.

A system control module 13 provides overall control over the apparatus and includes an encoding/decoding process module 14 to perform an encoding/decoding process and transcoding process on video and audio signals by a predetermined coding method. This module 13 also performs, for instance, a demultiplexing/multiplexing process and resolution conversion process (scaling) on video and audio signals. An internal memory 15 temporarily stores encoded/decoded video data and audio data. The functions of the system control module 13 and encoding/decoding process module 14 can be preferably implemented by allowing a microprocessor to execute programs. However, all or part of the functions may be implemented by hardware.

An operating control module 16, which is to be operated by the user, includes, for instance, a recording/reproduction key and selection keys for selecting a recording mode and a dubbing mode. A display screen creation module 17 not only outputs the video signal to be displayed on a display module 18, but also provides the user with process selection and setup screens. The display module 18 displays an image. This module 18 may be divided into a display section within a finder and a movable display section that is mounted on the outside of a video camera housing.

A recording/reproduction module 20 accepts a hard disk (HDD) 21, an optical disc (e.g., BD or DVD) 22, and a memory card (e.g., SD card or Memory Stick) 23, and records video and audio data onto and reproduces video and audio data from these media in a predetermined file format.

As described above, the video camera apparatus according to the present embodiment can accept a plurality of recording media and directly record images picked up in the HD mode onto an HDD 21 and an optical disc 22 such as a BD. The video camera apparatus can also dub HD mode images recorded on the HDD 21 to a BD without impairing them. Further, the transcoding function of the encoding/decoding process module 14 can be used to convert the recording format of HD mode images recorded on the HDD 21 and dub and store the resulting images to a conventional DVD. This makes it possible to record and dub HD images in accordance with the user's operating conditions.

Conventional DVDs cannot handle HD mode images without impairing them (except when the AVCHD method is used). Therefore, HD images are first recorded on an HDD, then forwarded to the encoding/decoding process module 14, and converted into a DVD recording format (coding method and SD mode resolution). In this manner, the HD images can be dubbed to a DVD (this process is hereinafter referred to as transcode dubbing).

For example, transcode dubbing can be accomplished by recording HD images onto an HDD in the H.264 format, converting the recording format to the MPEG2 format, and changing the resolution (rate) to the SD mode. This makes it possible to dub the HD images onto a DVD.

FIG. 2 is a block diagram illustrating the internal configuration of the system control module 13 that performs a transcoding dubbing process. An operation performed during the transcode dubbing process for dubbing HD mode image signals recorded on the HDD 21 to the DVD 22 will be described with reference to FIG. 2.

HD mode video data fed from the imaging unit 11 is encoded (in the H.264 format), multiplexed with audio data, and recorded on the HDD 21 as stream data. A signal demultiplexer (DEMUX) 31 separates the stream data into video data and audio data. An internal audio memory 15b stores the separated audio data. A decoder 32 decodes the separated video data.

A resolution conversion module (scaler) 33 converts the resolution (rate) of the decoded HD mode video data to a value (SD mode) appropriate for the DVD 22. For example, the rate is converted from 384 Kbps to 256 Kbps. An internal video memory 15a stores the resolution-converted video data. An encoder 34 encodes (transcodes) the video data stored in the internal video memory 15a in a recording format (MPEG2 format) appropriate for DVDs. A multiplexer (MUX) 35 multiplexes the encoded video data and the audio data stored in the internal audio memory 15b, and records (dubs) the resulting data onto the DVD 22 as stream data.

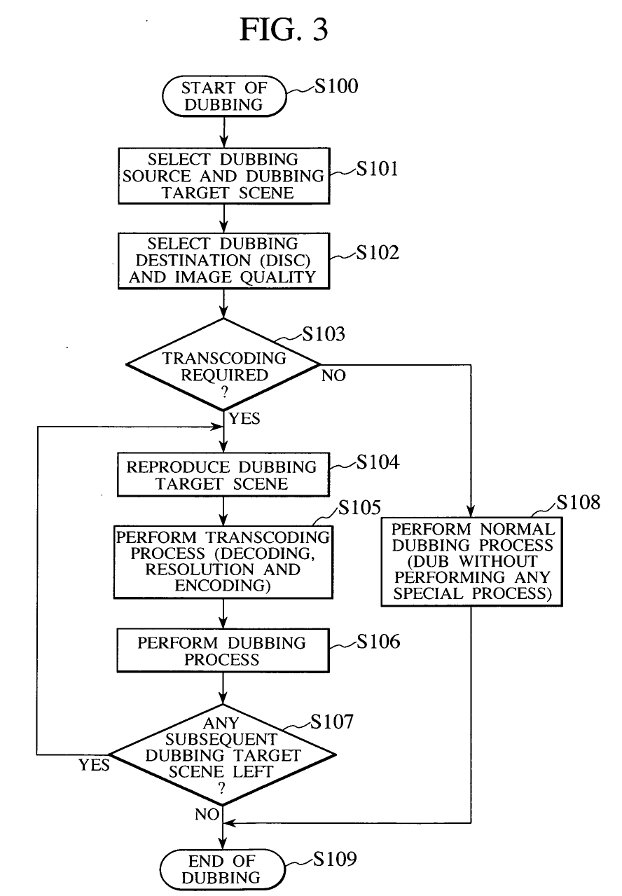

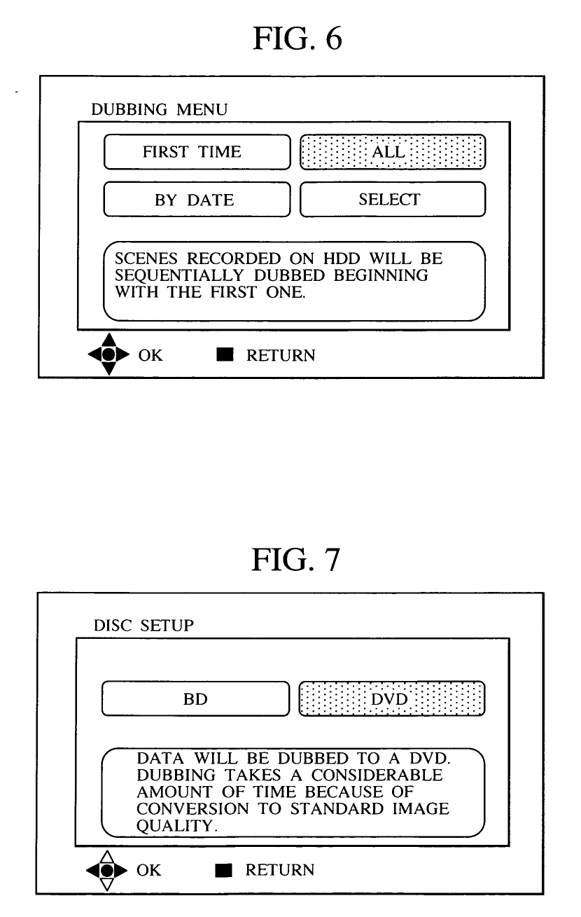

FIG. 3 is a flowchart illustrating the steps for performing a dubbing process. When the user presses a dubbing button to issue an instruction for starting the process (step S100), the display module 18 opens a screen for setting various dubbing conditions, allowing the user to make selections (steps S101 and S102). Examples of various setup screens will now be described with reference to FIGS. 6 to 10.

FIG. 6 shows a “Dubbing Menu” screen. This screen is used to specify dubbing target scenes by selecting one of four different modes. The user chooses “First Time” when only undubbed scenes are to be automatically searched for and dubbed. The user chooses “All” when all scenes are to be dubbed. The user chooses “By Date” when only scenes picked up on a particular day are to be automatically searched for and dubbed. The user chooses “Select” when only favorite scenes are to be selected for dubbing purposes.

FIG. 7 shows a “Disc Setup” screen. This screen is used to specify a dubbing destination disc. More specifically, this screen is used to specify whether a BD or DVD is inserted into an optical disc drive.

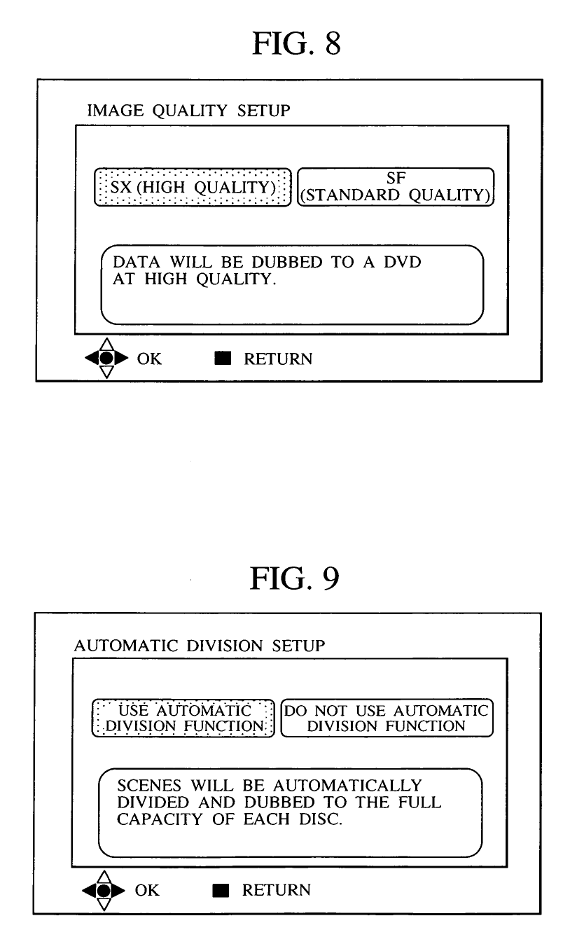

FIG. 8 shows an “Image Quality Setup” screen. This screen is used to specify the image quality for dubbing. When, for instance, images are to be dubbed to a DVD, either SX (high quality) or SF (standard quality) should be selected as the dubbing image quality.

FIG. 9 shows an “Automatic Division Setup” screen. This screen is used to choose an option for automatically dividing scenes at the time of dubbing. When an automatic division option is chosen, target scenes will be divided, stored onto a plurality of discs, and recorded to the full capacity of each disc.

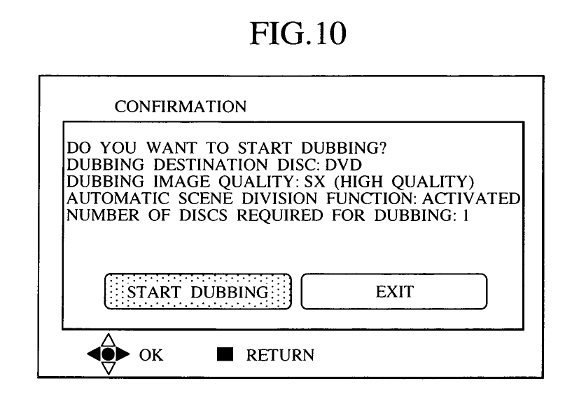

FIG. 10 shows a “Confirmation” screen. This screen displays the dubbing conditions that are selected and set up as described above, and prompts the user to confirm the dubbing conditions and start a dubbing process.

After the various dubbing conditions are set up, step S103 is performed to judge whether transcoding is needed. If the dubbing source and destination differ in the video data coding method and resolution, it is necessary to perform a transcoding process and convert the resolution. If, for instance, H.264 HD video data exists at the dubbing source while a DVD exists at the dubbing destination, transcoding is needed. If, on the other hand, a BD exists at the dubbing destination, dubbing can be accomplished without performing a transcoding process.

If the judgment result obtained in step S103 indicates that transcoding is needed, step S104 is performed to reproduce a dubbing target scene from the dubbing source. Next, step S105 is followed to perform a data transcoding process (decoding, resolution conversion, and encoding). Step S106 is then performed to dub the resulting data to a disc at the dubbing destination. If any subsequent dubbing target scene remains at the dubbing source (step S107), steps S104 to S106 are repeatedly performed to reproduce and transcode it. If, on the other hand, the judgment result obtained in step S103 indicates that transcoding is not needed, step S108 is performed to directly dub the data at the dubbing source at high speed.

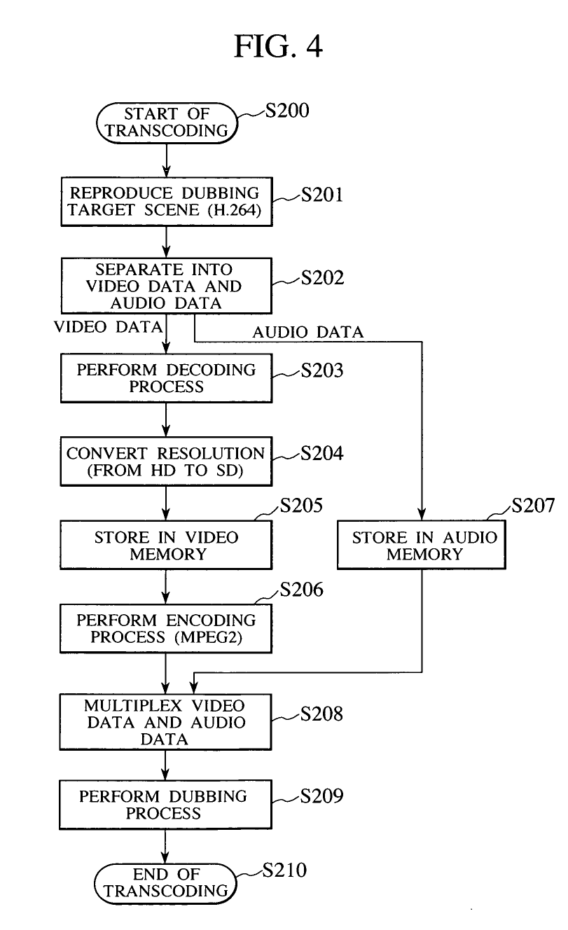

FIG. 4 is a flowchart illustrating in detail the transcoding process (steps S104 to S106), which is a part of the dubbing process shown in FIG. 3. FIG. 4 assumes that a transcoding process is performed to convert video data encoded in the H.264 format into the MPEG2 format and switch from the HD mode to the SD mode.

First of all, step S201 is performed to reproduce a dubbing target scene from the HDD at the dubbing source. The signal demultiplexer 31 separates the reproduced stream data into video data and audio data (step S202). Step S207 is then performed to store the separated audio data in the audio memory 15b.

The decoder 32 decodes the separated video data (step S203). The resolution conversion module (scaler) 33 converts the resolution (rate) of the decoded video data from the HD mode to the SD mode (step S204), and stores the resulting data in the video memory 15a (step S205). The encoder 34 reads the video data from the video memory 15a and encodes it in the MPEG2 format (step S206).

The multiplexer 35 multiplexes the video data encoded in the MPEG2 format and the audio data read from the audio memory 15b to generate stream data (step S208). The generated stream data is then dubbed to a DVD at the dubbing destination (step S209).

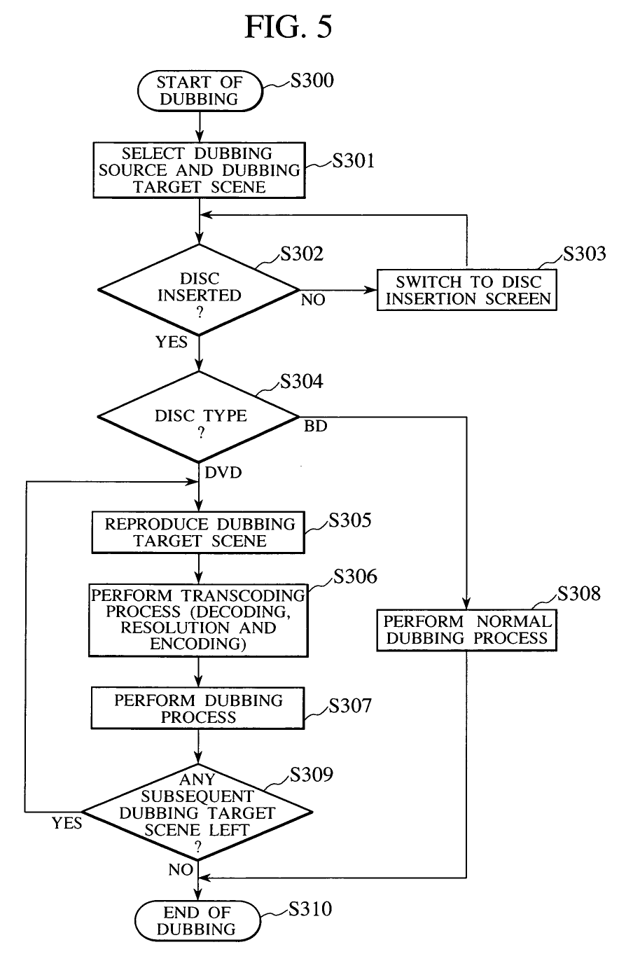

FIG. 5 is a flowchart illustrating the steps that are performed to automatically judge a dubbing destination disc within the dubbing process shown in FIG. 3. Steps different from those in FIG. 3 will now be described.

After completion of dubbing source and dubbing target scene selection (step S301), step S302 is performed to judge whether there is an inserted disc at the dubbing destination. If no disc is inserted, a message appears to prompt for disc insertion (step S303). If a disc is inserted, the system control module 13 automatically judges the type of the inserted disc (step S304). The disc type is judged, for instance, by measuring the distance (focal depth) between the disc surface and recording surface. Further, the information, for instance, about the recording format is obtained from disc management information. A necessary process is then automatically selected in accordance with the obtained information. If the obtained judgment result indicates that a DVD is inserted, a transcoding process (steps S305 and beyond) is performed because transcoding is needed. If, on the other hand, the obtained judgment result indicates that a BD is inserted, a normal dubbing process is performed because transcoding is not needed (steps S308 and beyond).

Since the type of the inserted disc is automatically judged in the above instance, there is no possibility of the user making incorrect selections for setup purposes. For example, this automatic judgment function makes it possible to prevent the user from making an incorrect attempt to dub images to a DVD in the HD mode.

As described above, the present embodiment makes it possible to convert HD mode video data on an HDD to SD mode data, dub the resulting video data to highly compatible DVDs, and distribute them to other people, thereby providing enhanced user-friendliness.

Although the present embodiment has been described on the assumption that HD mode images recorded on an HDD are to be converted to SD mode images and dubbed to a DVD, HD mode images recorded on a BD can be dubbed to a DVD through an HDD. It goes without saying that SD mode images can be directly dubbed between an HDD and a BD or DVD. Further, the data stored on an HDD can also be dubbed to a memory card.

As described above, the video camera apparatus according to the present embodiment can accept a plurality of recording media such as an HDD, a BD, and a DVD, and perform data conversion and dubbing processes in accordance with the environment employed by the user. This enables the user to choose from a wide variety of media and formats for storing picked-up images, thereby providing enhanced user-friendliness.

While we have shown and described a particular embodiment in accordance with our invention, it should be understood that the disclosed embodiment is susceptible of changes and modifications without departing from the scope of the invention. Therefore, we do not intend to be bound by the details shown and described herein but intend to cover all such changes and modifications that fall within the ambit of the appended claims.

In the above embodiments each elements at least expressed as “module” can be realized by a hardware or a software or both to achieve the function and the operation explained in the part.

What is claimed is:

1. A video camera apparatus that records a video signal picked up by an imaging unit onto a hard disk medium and an optical disc medium, the video camera apparatus comprising:
an encoding/decoding process module which performs an encoding/decoding process on the video signal by a predetermined coding method;
a resolution conversion module which converts the resolution of the video signal;
a recording/reproduction module which records the video signal onto the hard disk medium and the optical disc medium and reproduces the recorded video signal; and
a control module which controls the encoding/decoding process module, the resolution conversion module, and the recording/reproduction module;
wherein the control module encodes a high-definition mode image signal picked up by the imaging unit into video data in a first coding format, records the resulting video data onto the hard disk medium, performs a transcoding process to transcode the video data in the first coding format, which is reproduced from the hard disk medium, to video data in a second coding format while performing a resolution conversion process to convert the resolution of the video data in the first coding format to obtain standard mode video data, and dubs the resulting video data to the optical disc medium.

2. The video camera apparatus according to claim 1, wherein the optical disc medium is a DVD; wherein the first coding format is the H.264 format; and wherein the second coding format is the MPEG2 format.

3. The video camera apparatus according to claim 1, wherein the control module judges in accordance with the type of the optical disc medium whether the transcoding process and the resolution conversion process should be performed.

4. The video camera apparatus according to claim 3, wherein the control module determines the type of the optical disc medium and judges whether the transcoding process and the resolution conversion process should be performed.

5. The video camera apparatus according to claim 3, further comprising:
a display module which displays images,
wherein the display module opens screens that allow a user to specify the optical disc medium at a dubbing destination and the image quality for dubbing.
